(19) United States
(12) Patent Application Publication
(10) Pub. No.: US 2007/0239854 A1
(43) Pub. Date: Oct. 11, 2007

(54) Method of migrating process domain

(76) Inventors: Gopalakrishnan Janakiraman, Palo Alto, CA (US); Dinesh Kumar Subhraveti, Milpitas, CA (US); Jose Renato Santos, Palo Alto, CA (US); Yoshio Frank Turner, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/401,614

(22) Filed: Apr. 11, 2006

(51) Int. Cl. G06F 15/16

(52) U.S. Cl. 709/218

(57) ABSTRACT

An embodiment of a method of migrating the process domain includes attaching a process-domain interface that includes an internet protocol address to the process domain. The process-domain interface along with the process domain is moved from a first host to a second host.

### RELATED APPLICATIONS

This application is related to U.S. application No. (Attorney Docket No. 200406665-1), filed on (the same day as this application), the contents of which is hereby incorporated by reference.

### FIELD OF THE INVENTION

The present invention relates to the field of computing. More particularly, the present invention relates to the field of computing where a process domain is migrated from a first host to a second host.

### BACKGROUND OF THE INVENTION

A computer in operation includes hardware, software, and data. The hardware typically includes a processor, memory, storage, and I/O (input/output) devices coupled together by a bus. The software typically includes an operating system and applications. The applications perform useful work on the data for a user or users. The operating system provides an interface between the applications and the hardware. The operating system performs two primary functions. First, it allocates resources to the applications. The resources include hardware resources—such as processor time, memory space, and I/O devices—and software resources including some software resources that enable the hardware resources to perform tasks. Second, it controls execution of the applications to ensure proper operation of the computer.

Often, the software is conceptually divided into a user level, where the applications reside and which the users access, and a kernel level, where the operating system resides and which is accessed by system calls. Within an operating computer, a unit of work is referred to as a process. A process is computer code and data in execution. The process may be actually executing or it may be ready to execute or it may be waiting for an event to occur. The system calls provide an interface between the processes and the operating system.

Checkpointing is a technique employed on some computers where processes take significant time to execute. By occasionally performing a checkpoint of processes and resources assigned to processes, the processes can be restarted at an intermediate computational state in an event of a system failure. Migration is a technique in which running processes are checkpointed and then restarted on another computer. Migration allows some processes on a heavily used computer to be moved to a lightly used computer. Checkpointing, restart, and migration have been implemented in a number of ways.

In The Design and Implementation of Zap: A System for Migrating Computing Environments, Proc. OSDI 2002, Osman et al. teach a technique of adding a loadable kernel module to a standard operating system to provide checkpoint, restart, and migration of processes implemented by existing applications. The loadable kernel model divides the application level into process domains and provides virtualization of resources within each process domain. Such virtualization of resources includes virtual process identifiers and virtualized network addresses. Processes within one process domain are prevented from interacting with processes in another process domain using inter-process communication techniques. Instead, processes within different process domains interact using network communications and shared files set up for communication between different computers.

Virtualized network addresses are translated to a node's network address (e.g., a hardware interface network address) by the loadable kernel module that manages the process domains. A virtualized network address is only visible to processes within the process domain where the processes execute. For example, to others on a computer network that communicate with a process domain that employs a virtualized network address, the process domain is addressed using the network address of the node that hosts the process domain. The loadable kernel module translates the network address of the node to the virtualized network address for the processes within the process domain.

Checkpointing in the technique taught by Osman et al. records the processes in a process domain as well as the state of the resources used by the processes. Because resources in the process domain are virtualized, restart or migration of a process domain includes restoring resource identifications to a virtualized identity that the resources had at the most recent checkpoint.

While the checkpoint, restart, and migration techniques taught by Osman et al. show promise, several areas could be improved. In particular, the virtualized network addresses are only visible to processes within a process domain. Outside of the process domain, other process domains or other nodes on a network communicate with the process domain having the virtualized network addresses using the node's network address.

In Published PCT Patent Application WO 2004/015513, Vertes et al. teach a method of migrating connections within a cluster that employs a cluster network address. Each computer in a cluster has a network address and also receives communications addressed to the cluster network address. At any given time, a particular computer of the cluster is authorized to accept communication addressed to the cluster network address. The authorization to accept communication addressed to the cluster network address may be transferred at a point-in-time to another node of the cluster.

In the method taught by Vertes et al., when a connection is setup within the cluster that may be subject to migration, the connection employs the cluster network address. Initially, the computer which hosts the connection before the migration has the authority to receive communications addressed to the cluster network address. When the connection is migrated to another computer, the authority to receive communications addressed to the cluster network address is also transferred to the other computer. While the method taught by Vertes et al. works for a cluster of computers, it cannot function outside of the cluster.

### SUMMARY OF THE INVENTION

The present invention is a method of migrating a process domain. According to an embodiment, the method of migrating the process domain includes attaching a process-domain interface that includes an internet protocol address to the process domain. The process-domain interface along with the process domain is moved from a first host to a second host.

### BRIEF DESCRIPTION OF THE DRAWINGS

The present invention is described with respect to particular exemplary embodiments thereof and reference is accordingly made to the drawings in which:

FIG. 1 illustrates a computer network in accordance with embodiments of the present invention;

FIGS. 2A and 2B illustrate another computer network in accordance with embodiments of the present invention;

FIG. 3 illustrates an embodiment of a method of migrating a process domain of the present invention as a flow chart; and

FIG. 4 illustrates another embodiment of a method of migrating a process domain of the present invention as a flow chart

### DETAILED DESCRIPTION OF A PREFERRED EMBODIMENT

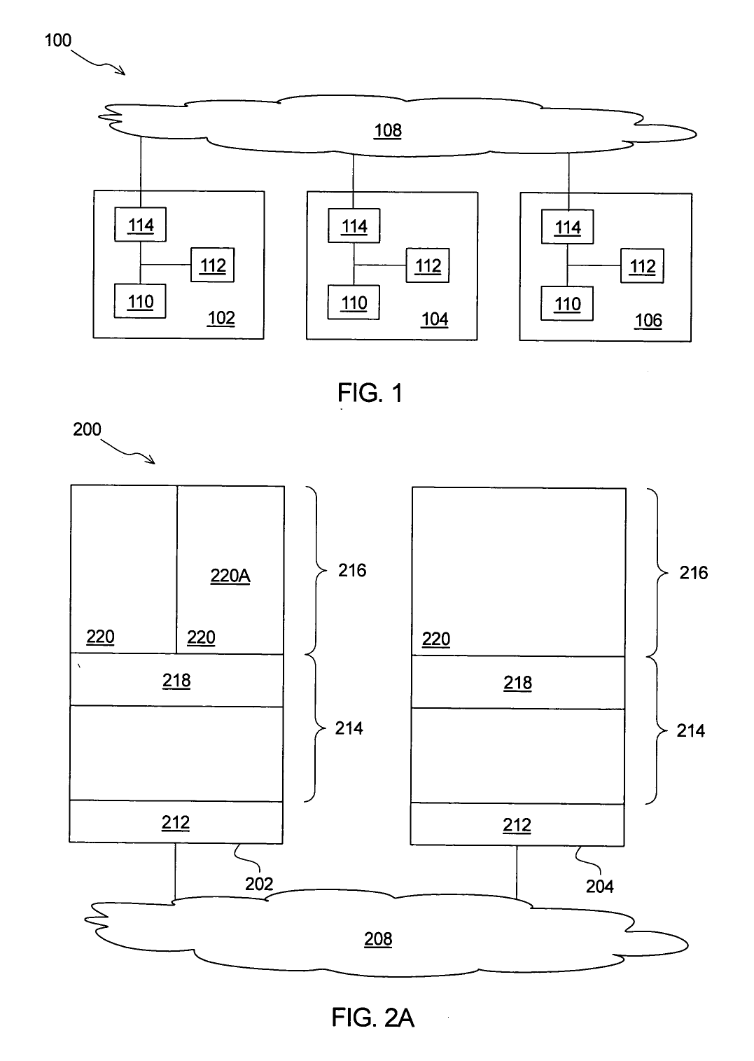

A computer network which employs a method of migrating a process domain in accordance with embodiments of the present invention is illustrated in FIG. 1. The computer network comprises first through third hosts, 102 . . . 106, coupled by a communication medium 108. The first through third hosts, 102 . . . 106, may be referred to as nodes. Each of the first through third hosts, 102 . . . 106, comprises a computer that includes a processor 110, memory 112, and a network interface 114. In accordance with an embodiment of the present invention, a process domain (not shown) may be migrated from the first host 102 to the second or third host, 104 or 106. The first through third hosts, 102 . . . 106, may communicate over the communication medium 108. For example, the first host 102 may communicate with the second or third host, 104 or 106, by exchanging messages over the communication medium 108.

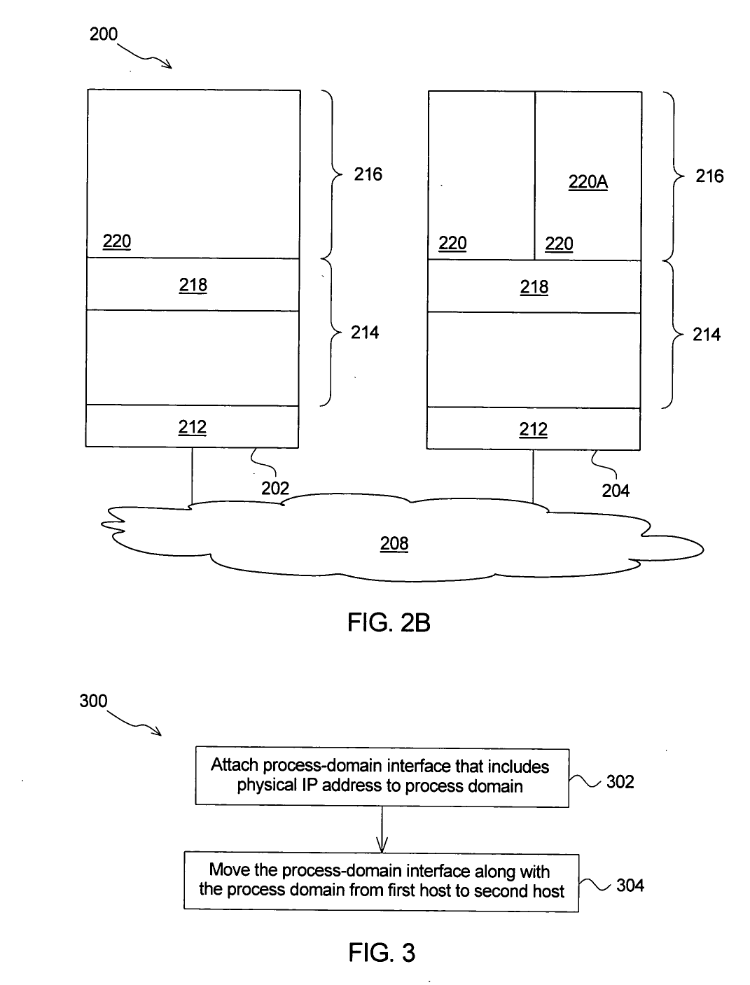

Another computer network that employs a method of migrating a process domain in accordance with embodiments of the present invention is illustrated in FIGS. 2A and 2B. The computer network 200 includes first and second host computer systems 202 and 204 coupled by a communication medium 208. The first and second host computer systems, 202 and 204, each include computer hardware 212, an operating system kernel 214, and a user level 216. The operating system kernel 214 includes a kernel module 218 (e.g., a loadable kernel module), which may form one or more process domains 220 at the user level. FIG. 2A illustrates the computer network 200 prior to migration of a particular process domain 220A from the first host computer system 202 to the second host computer system. FIG. 2B illustrates the computer network 200 after migration of the particular process domain 220A from the first host computer system 202 to the second host computer system 204.

An embodiment of a method of migrating a process domain of the present invention is illustrated as a flow chart in FIG. 3. The method 300 begins with a first step 302 of attaching a process-domain interface that includes an IP address to the process domain. The IP address may have been statically assigned to the process-domain interface or it may have been dynamically assigned to the process-domain interface.

In an embodiment, the method 300 may further include creating the process-domain interface. For example, if the operating system is Linux, the process-domain interface may be a Virtual network Interface (VIF) that may be created through a command such as:

ifconfig eth0:<virtual-interface-number> <ip-address> netmask <net-mask>

In an embodiment, the method 300 may further include associating the process-domain interface with the process domain. For example, the process-domain interface may be associated with the process domain at about the time of creating the process domain or creating the process domain may include associating the process-domain interface with the process domain. Or, for example, the process domain may exist for a time prior to creating the process-domain interface and associating the process-domain interface with the process domain.

It will be readily apparent to one skilled in the art that, while this discussion contemplates associating a process-domain interface with the process domain, multiple process-domain interfaces may be associated with the process domain.

In an embodiment, attaching the process-domain interface to the process domain may include attaching the process domain interface to a process within the process domain. For example, the process may issue a bind system call and a loadable kernel module may intercept the bind system call using a wrapper function that replaces a network address argument of the bind system call with the IP address of the process-domain interface. Or, for example, the process may issue a connect system call and the loadable kernel module may intercept the connect system call using a wrapper function that invokes a bind system call that includes the IP address of the process-domain interface as an argument.

In an embodiment, the method 300 may further include intercepting a sendto or recvfrom system call when the sendto or recvfrom system call, respectively, is first invoked for a particular User Datagram Protocol (UDP) socket. When the sendto or recvfrom system call is first invoked for the particular socket, a wrapper function invokes a bind system call with the IP address of the process-domain interface as an argument before executing the sendto or recvfrom system call, respectively.

In an embodiment, attaching the process domain interface to the process domain further includes binding a local end of a Transmission Control Protocol (TCP) connection to the process-domain interface. Binding the local end of the TCP connection to the process-domain interface may include intercepting a bind system call and employing policy based routing. If the bind system call is made by a process within the process domain, a caller IP address is replaced with the IP address of the process-domain interface.

The policy based routing is employed to map connection requests from processes within the process domain to the process-domain interface. In an embodiment, the policy based routing replaces a source IP address of network packets sent from processes within the process domain with the IP address of the process-domain interface.

In an embodiment, attaching the process domain interface to the process domain further includes binding a UDP local end-point to the process-domain interface. Binding the UDP local end-point may include intercepting a first invocation of a bind or recvfrom system call, whichever occurs first, and employing the policy based routing. If the bind system call is invoked first, the IP address of the process-domain interface is inserted as an argument of the bind system call before allowing it to execute. If the recvfrom system call is invoked first, a wrapper function invokes a bind system call with the IP address of the process-domain interface as an argument before executing the recvfrom system call. Policy based routing allows marking of packets based on criteria like the Process ID (PID) of the process that originated the packet. Marked packets can then be directed to use a separate routing table that is different from the host's global routing table (i.e., the hardware platform's routing table). Policy based routing provides user level interfaces to create and modify the routing tables and to setup rules for marking packets. Packets originating from processes within the process domain are marked with the process domain ID. The policy based routing mechanism is configured to mark the IP address of the process-domain interface as the source IP address of the packets. This may be accomplished in first through third sub-steps.

In the first sub-step, a first policy routing rule for marking packets originating within the process domain with the process domain ID is established. For example, if the operating system is Linux, the firs policy routing rule may be established through a command such as:

iptable -t mangle -D OUTPUT -m owner --pid owner <pid of process within process domain> -j MARK --set-mark <process domain id>

In the second sub-step, a process domain-specific routing table is created that contains process-domain interfaces of the process domain and rules for selecting among them. For example, if the operating system is Linux, the process domain-specific routing table may be created using a command such as:

ip route add default <process domain IP address> table <process domain id>

In the third sub-step, a second policy routing rule is established that directs packets marked with the process domain ID to the process domain-specific routing table so that the source IP address of the packet is populated with the IP address of the process-domain interface. For example, if the operating system is Linux, the second policy routing rule may be established through a command such as:

ip rule add fwmark <process domain id> table <process domain id>

The first through third sub-steps ensure that the communication over a socket is addressed to the IP address of the process domain by binding a connect (SYN) packet generated by a connect system call to the IP address.

In an embodiment, the method 300 may further include the kernel module intercepting an ioctl system call invoked from within the process domain, which seeks to determine properties of a network interface. Normally, an ioctl system call returns the properties of a physical network interface. Here, the kernel module returns the properties of the process-domain interface.

In a second step 304, the process-domain interface along with the process domain is moved from a first host to a second host. The second host is within a subnet that includes the first host. A subnet is a portion of a network that shares a common address component. On TCP/IP networks, subnets are defines as the devices whose IP address have the same prefix.

In an alternative embodiment, the process-domain interface further includes a virtual Medium Access Control (MAC) address that is different from the MAC address of the physical interface, and can be migrated with a process-domain to a new host. According to such an embodiment, the IP address of the process domain interface may be statically or dynamically assigned. In this embodiment the physical network interface is configured in promiscuous mode, such that it can receive packets that have a destination MAC address different from the virtual MAC address of the interface. In addition packets transmitted on behalf of the IP address of the process-domain domain interface have their source MAC address modified to the virtual MAC address. In Linux this can be implemented using a netfilter hook function implemented in a loadable kernel module, which is activated with the Linux netfilter function nf_register hook, using the NF_IP_POST_ROUTING hook identifier.

In another alternative embodiment, the method 300 further comprises employing a first MAC address of a physical interface of the first host while the process domain resides on the first host and employing a second MAC address of a physical interface of a second host while the process domain resides on the second host. The alternative embodiment may further comprise statically or dynamically assigning the IP address to the process-domain interface. The Address Resolution Protocol (ARP) is used to update the mapping of the IP address of the process-domain interface to the second MAC address after the process domain has been moved from the first host to the second host. Since each host in the subnet caches (i.e., saves) a copy of this mapping in its ARP cache (i.e., an ARP temporary memory), an unsolicited ARP broadcast message is sent to inform all hosts that the IP to MAC address mapping has changed. For example, in Linux this can be performed using the arping command:

arping -c 1 -U -I <physical_network_interface> <IP address>

If the IP address is dynamically assigned to the process-domain interface, a DHCP (Dynamic Host Configuration Protocol) server which assigns and renews the IP address of the process-domain interface must use a MAC address that does not change after migration. Otherwise the IP address will not be renewed when the current lease expires. For supporting dynamically assigned IP addresses the process-domain interface may further include a surrogate MAC address, which does not change after a process domain is migrated. When an IP address is requested from the DHCP server or when a renewal for a lease for an IP address is requested from the DHCP server, the surrogate MAC address is included with the request. This behavior can be implemented by intercepting ioctl system calls which asks the hardware address of a network interface (i.e. the SIOCGHWADDR ioctl call) and modifying it to return the surrogate MAC address of the virtual interface. This will cause a user level DHCP client inside the process-domain to insert the surrogate MAC address into the DHCP request that it sends to the DHCP server.

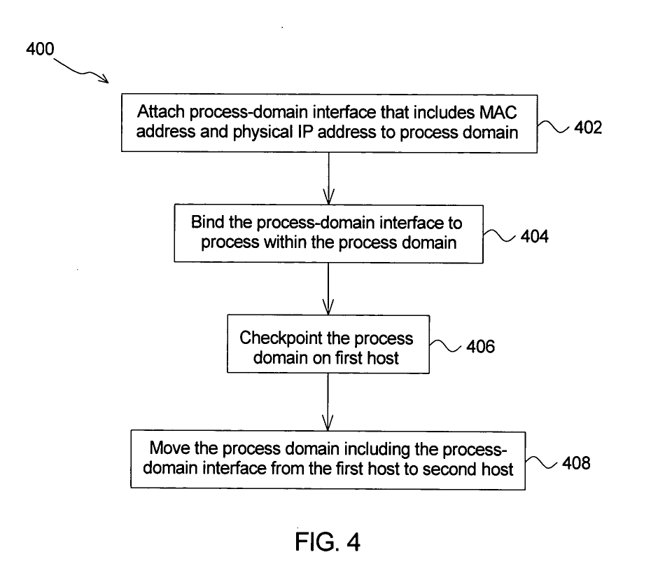

Another embodiment of a method of migrating a process domain of the present invention is illustrated as a flow chart in FIG. 4. The method 400 begins with a first step 402 of creating a process-domain interface that includes a MAC address and a IP address. In a second step 404, the process-domain interface is bound to a process within the process domain.

The method 400 continues with a third step 406 of checkpointing the process domain on a first host. Checkpointing the process domain on the first host may include checkpointing communication state information and information regarding processes, threads (i.e., processes that share at least some resources), memory, shared memory, processor state, file descriptors, pipes, signals, terminal state, semaphores, and other state information. For example, checkpointing the communication state information on the first host may be performed an embodiment of a method of checkpointing a communication state of a process taught in related U.S. patent application No. (Attorney Docket No. 200406665-1) filed on (the same day as this application), which is incorporated by reference in the related application section above.

In a fourth step 408, the process domain including the process-domain interface is moved to a second host. The process-domain may then be restarted on the second host.

The foregoing detailed description of the present invention is provided for the purposes of illustration and is not intended to be exhaustive or to limit the invention to the embodiments disclosed. Accordingly, the scope of the present invention is defined by the appended claims.

What is claimed is:

1. A method of migrating a process domain comprising the steps of:
attaching a process-domain interface that includes an internet protocol address to the process domain; and
moving the process-domain interface along with the process domain from a first host to a second host.

2. The method of claim 1 wherein the process-domain interface further includes a virtual medium access control address.

3. The method of claim 1 further comprising statically assigning the internet protocol address to the process-domain interface.

4. The method of claim 1 further comprising dynamically assigning the internet protocol address to the process-domain interface.

5. The method of claim 1 wherein the process domain operates in a promiscuous mode.

6. The method of claim 1 further comprising employing a first medium access control address of the first host while the process domain resides on the first host and employing a second medium access control address of the second host while the process domain resides on the second host.

7. The method of claim 6 wherein an address resolution protocol updates a mapping of the second medium access control address to the internet protocol address after the process domain has been moved from the first host to the second host.

8. The method of claim 6 wherein the process-domain interface further comprises a surrogate medium access control address and further comprising using the surrogate medium access control address when communicating with a dynamic host configuration protocol server to request that the dynamic host configuration protocol server dynamically assign the internet protocol address to the process domain or to request that the dynamic host configuration protocol server renew a lease for the internet protocol address.

9. The method of claim 1 wherein attaching the process-domain interface to the process domain includes attaching the process-domain interface to a process within the process domain and further comprising binding a local end of a transmission control protocol connection to the process-domain interface.

10. The method of claim 9 wherein attaching the process-domain interface to the process within the process domain comprises the process issuing a bind system call and a loadable kernel module intercepting the bind system call using a wrapper function which replaces a network address argument of the bind system call with the internet protocol address of the process-domain interface.

11. The method of claim 9 wherein attaching the process-domain interface to the process within the process domain comprises the process issuing a connect system call and a loadable kernel module intercepting the connect system call using a wrapper function which invokes a bind system call that includes the internet protocol address of the process-domain interface as an argument.

12. The method of claim 1 further comprising intercepting a sendto or recvfrom system call that employs a user datagram protocol socket and invoking a bind system call with the internet protocol address of the process-domain interface before executing the sendto or recvfrom system call, respectively.

13. The method of claim 1 further comprising creating the process-domain interface.

14. The method of claim 13 further comprising creating the process domain.

15. The method of claim 14 further comprising associating the process-domain interface to the process domain at about a time of creating the process domain.

16. The method of claim 14 further comprising binding a local end of the transmission control protocol connection to the process domain interface which includes:
intercepting a bind system call and, if the bind system call is made by a process within the process domain, replacing a caller internet protocol address with the internet protocol address of the process domain interface; and
employing policy based which sets a source internet protocol address of network packets sent from processes within the process domain to the internet protocol address of the process-domain interface.

17. The method of claim 14 further comprising binding a user datagram protocol local end-point to the process-domain interface which includes:
intercepting a first invocation of a bind or recvfrom system call, whichever occurs first; and
if the bind system call is invoked first, inserting the internet protocol address of the process-domain interface as an argument of the bind system call before allowing the bind system call to execute;
otherwise, employing a wrapper function to invoke an intermediary bind system call with the internet protocol address of the process-domain interface as an argument of the intermediary bind system call before executing the recvfrom system call.

18. The method of claim 1 further comprising intercepting an ioctl system call that seeks to determine properties of the process-domain interface and returning the properties of the process domain interface.

19. A method of migrating a process domain comprising the steps of:
creating a process-domain interface that includes a virtual medium access control address and an internet protocol address;
binding the process-domain interface to a process within the process domain;
checkpointing the process domain including the process-domain interface on a first host;
moving the process domain including the process-domain interface to a second host.

20. A computer readable medium comprising computer code for implementing a method of migrating a process domain, the method migrating the process domain comprising the steps of:
attaching a process-domain interface that includes a internet protocol address to the process domain; and
moving the process-domain interface along with the process domain from a first host to a second host.
